(19) United States
(12) Patent Application Publication
(10) Pub. No.: US 2014/0215377 A1
(43) Pub. Date: Jul. 31, 2014

(54) PERFORMING DATA OPERATIONS WHILE PRESERVING GRAPHICAL USER INTERFACE REAL-ESTATE

(71) Applicant: HEWLETT-PACKARD DEVELOPMENT COMPANY, L.P., Houston, TX (US)

(72) Inventors: Andres Odio Vivi, Heredia (CR); Sebastian Arguello Gutierrez, Santo Domingo (CR)

(73) Assignee: Hewlett-Packard Development Company, L.P., Houston, TX (US)

(21) Appl. No.: 13/754,585

(22) Filed: Jan. 30, 2013

(51) Int. Cl. G06F 3/0484

(52) U.S. Cl. CPC G06F 3/0484
USPC 715/780

(57) ABSTRACT

Systems, methods, and machine-readable and executable instructions are provided for performing data operations while preserving graphical user interface real-estate. A data field with a context can be displayed on a graphical user interface. A query field that includes a number of entry fields that stretch in a first direction and are listed in a second direction can be displayed for filtering the data field on the graphical user interface, while maintaining the context of the data field, wherein the data field and the query field are displayed concurrently.

### BACKGROUND

A graphical user interface (GUI) is a type of interface that can allow a user to interact with an electronic device using images. A GUI can display a logo, advertising, and/or a functional feature, through which a user can interact with the electronic device. In an example, functional features can include graphical icons that can be selected and/or query fields in which information can be entered. For instance, graphical icons can be selected to direct the electronic device to perform a particular function and/or information can be entered into query fields to filter and/or search information.

### BRIEF DESCRIPTION OF THE DRAWINGS

FIG. 1 is an example of a computing system for performing data operations while preserving graphical user interface real-estate according to the present disclosure.

FIG. 2 is a flow chart illustrating an example of a method for performing data operations while preserving graphical user interface real-estate according to the present disclosure.

FIG. 3 illustrates a block diagram of an example of a computer-readable medium in communication with processing resources of a computing device according to the present disclosure.

### DETAILED DESCRIPTION

A user can interact with functional features displayed on a GUI, directing an electronic device associated with the GUI to perform certain functions. However, user interaction with the GUI can be made difficult as a result of the functional features displayed on the GUI being crowded due to limited real-estate associated with the GUI. Real-estate associated with the GUI can be limited as a result of a screen size of a display that includes the GUI. In addition, real-estate associated with the GUI can be limited as a result of logos, advertising, and/or functional features displayed on the GUI.

In an example, the functional features can include an entry field, which can be an input field where criteria can be entered to perform filtering and or searching of data based on the entered criteria. An entry field can be a single input field that stretches horizontally across the GUI. However, the length of the query field can be limited as a result of the real-estate associated with the GUI. For instance, the existing space reserved for the entry field on the GUI may be limited as a result of the screen size of the display that includes the GUI, logos, advertising, and/or other functional features displayed on the GUI.

Criteria entered into the entry field can be in the form of characters (e.g., letters, symbols, numbers). Criteria can be entered into the entry field and filtering and/or searching can be completed based on the entered criteria and the results of the filtering and/or searching can be displayed in a data field. However, as a number of criteria entered into the entry field increases, additional space in the entry field for entering criteria decreases. As such, rather than limiting the number of criteria to the amount of space in the entry field, some of the criteria are hidden from view as the number of criteria entered into the entry field surpasses the amount of available space in the entry field.

Viewing the hidden criteria can be accomplished by scrolling through the criteria that have been entered into the entry field. However, the number of criteria viewed at one time is limited to those that fit into the length of the entry field. For instance, 5 criteria may be entered into an entry field, but only 2 criteria may be displayed at a time in the entry field as a result of the limited length of the entry field.

As a result, interaction between the user and the entry field can be limited. In an example, a user may not be able to look at the entry field and identify all of the criteria that are being used to filter and/or search data. For instance, when a user looks at the entry field, some criteria can be hidden from the user's view as a result of the number of criteria entered into the entry field surpassing the amount of available space. The user, therefore, may need to scroll through the entry field to see portions of the applied criteria, but not all of the applied criteria at once.

In addition, a user attempting to edit a particular criterion in the entry field may have difficulty as a result of only a portion of the criteria being displayed. In an example, for the user to edit the particular criterion, the user may first have to click on the entry field and scroll through the entry field until the user finds the particular criterion. The user may then issue a command via a keyboard and/or via the GUI to delete the particular criterion, once it has been selected.

Increasing the size of the entry field can result in more room in the entry field to display criteria, however, this can also result in real-estate associated with the GUI being occupied, thus eliminating room for displaying logos, advertising, and/or additional functional features on the GUI. Elimination of logos, advertising, and/or additional functional features on the GUI can reduce income that is generated via ads, brand recognition generated via logos, and user friendliness associated with additional functional features. In addition, increasing the size of the entry field can make it difficult for the user to visually process a long string of characters and to identify individual characters and/or groups of characters for verification and/or select them for modification.

Alternatively, a larger entry field could be displayed to the user, which lists each of the criteria on a page that is separate from the data field. However, in order for the user to view the query field, the user must alternate between viewing the page that lists the entry field and the page that lists the query field. As such, the user can lose a reference point on a page that they are viewing as a result of having to switch between separate pages that contain the query field and the data field.

To help address the limitations associated with interaction between a user and the query field of the graphical user interface, systems, methods, and machine-readable and executable instructions are provided for performing data operations while preserving GUI real-estate. Preservation can include displaying a data field with a context on a graphical user interface. Preservation can include displaying a filter field that includes a number of query fields that stretch in a first direction and are listed in a second direction for performing an operation on the data field on the graphical user interface, while maintaining the context of the data field. Examples of the present disclosure can provide increased functional features associated with the GUI that are user friendly, while preserving GUI real-estate. In an example, criteria that are used for filtering and/or searching can be displayed concurrently with the data field, without changing the context of the data field. For instance, the criteria that are used for filtering and/or searching can be displayed concurrently with the data field while maintaining GUI real estate and without having to display the criteria on a different page than the data field.

In the present disclosure, reference is made to the accompanying drawings that form a part hereof, and in which is shown by way of illustration how a number of examples of the disclosure can be practiced. These examples are described in sufficient detail to enable those of ordinary skill in the art to practice the examples of this disclosure, and it is to be understood that other examples can be used and that process, electrical, and/or structural changes can be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

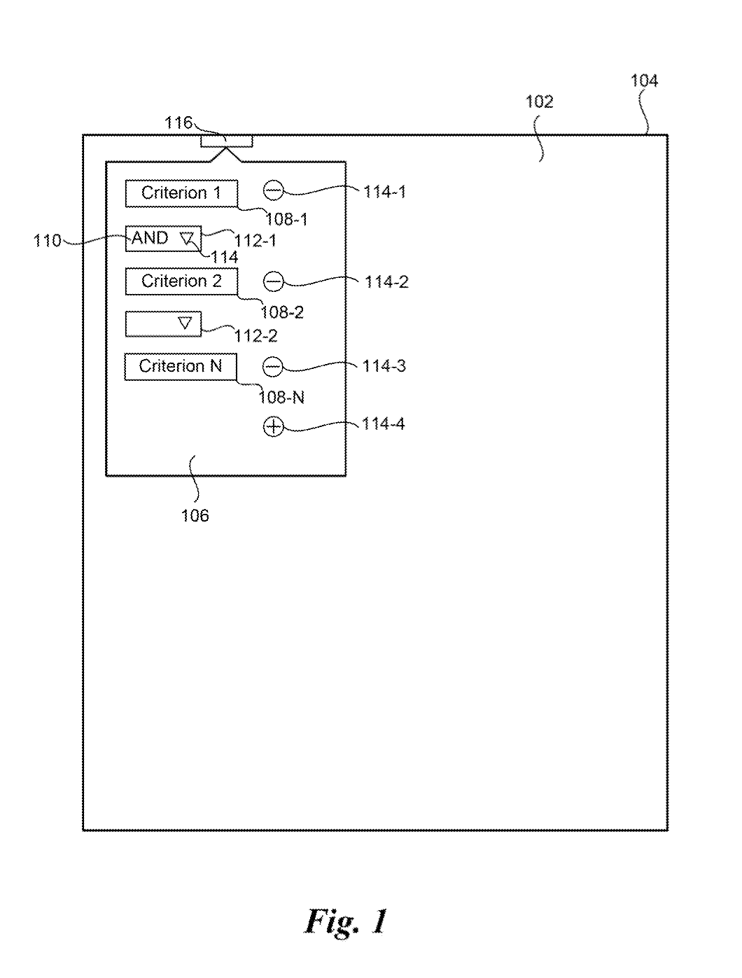

FIG. 1 illustrates an example of a system for performing data operations while preserving GUI real-estate. In an example, the system can include a data field 102 displayed on a GUI 104. The data field 102 can be a field that displays data with a context. For example, the context of the data can include characteristics associated with a visual presentation of the data on the GUI 104. For example, the context of the data can include formatting of the data (e.g., line spacing between data characters, character spacing between data characters, data character size, data font, data color). The context of the data can include formatting of the space that the data is presented on. For example, the formatting of the space can include dimensions of the data field 102, margins associated with the data field, a number of pages required to display the data field 102 and/or a query field 106.

The data can include data that has been filtered and/or searched for by a user, via the query field 106 that is displayed on the GUI 104. As discussed herein, the query field 106 can be displayed in a way that does not change the context of the data field 102. For example, displaying the query field 106 does not change the formatting of the data and/or the formatting of the space that the data is presented on. In addition, the query field 106 can display all criteria that are used to filter and/or search the data field 102, versus only a portion of the criteria.

As discussed herein, the data field 102 with the context can be displayed on the GUI 104. Various types of data can be displayed on the data field 102. In an example, various types of data can include emails, wireless access points, user accounts, lists of results compiled from searches (e.g., internet searches), although examples are not so limited.

The query field 106 can be displayed and can include a number of entry fields 108-1, 108-2, 108-N, herein collectively referred to as entry fields 108 in which criteria (e.g., Criterion 1, Criterion 2, Criterion N) can be entered. The entry fields 108 can stretch in a direction that is horizontal to the GUI 104 and can be listed in a direction that is vertical to the GUI 104. For example, the entry fields 108 can be displayed as a vertical list. By displaying the entry fields 108 in such a manner, more efficient use can be made of the space within the query field 106 and/or the data field 102 such that all of the criteria entered into each of the entry fields 108 can be viewed. In addition, each criterion can be more efficiently identified and/or manipulated as a result of spatial separation between query fields. For example, in contrast to one horizontal entry field where a user scrolls through the entry field in order to view each of the criteria, all of the criteria are presented on the query field 106 via each of the entry fields 108.

In an example, a relationship can be created between a first criterion (e.g., Criterion 1) entered into a first entry field 108-1 and a second criterion (e.g., Criterion 2) entered into a second entry field 108-2 via an operator 110 that is displayed on the query field 106. The operator 110 can be displayed in an operator field 112-1. In an example, the operator can be a Boolean operator and/or can be a mathematical operator, although examples are not so limited. Boolean operators can include, for example, AND, OR, and NOT. Mathematical operators can include, for example, >, <, ≧, ≦, and ==. For instance, as shown in FIG. 1, Boolean operator 110 (e.g., AND) requires both Criterion 1 in the first entry field 108-1 and Criterion 2 in the second entry field 108-2 to be present when filtering and/or performing a search. In addition, the operator can be a logical operator, although examples are not so limited.

The operator can be selected via a drop-down menu 114 in the operator field 112-1, for example. By default, the operator field 112-1 can be left blank and no operator can be displayed. For example, blank operator field 112-2 does not include an operator by default and therefore, when filtering and/or performing a search, data that is populated by the filtering and/or search will include Criterion 1 and Criterion 2 as a result of Boolean operator 110 being used and is not required to include Criterion N, but will be populated if the data does include Criterion N.

Examples of the present disclosure can cause the second entry field 108-2 to be displayed upon entry of a criterion into the first entry field 108-1. In an example, the first entry field 108-1 can be displayed upon display of the query field 106. In addition, a vertical length of the query field 106 can be adjusted upon entry of the criterion into the first entry field 108-1 in order to accommodate the second entry field within the query field 106. For example, the query field can be of a first dimension (e.g., vertical length, horizontal length) to display the first entry field 108-1 and can increase in size to a second dimension to accommodate the second entry field 108-2. By allowing the size of the query field 106 to grow with an increased number of query fields, real-estate associated with the GUI 104 can be preserved. For instance, if the size of the query field 106 is large enough to display multiple entry fields 108 when multiple entry fields are not being used, unnecessary GUI 104 real-estate can be occupied by the query field 106. However, if the size of the query field 106 grows with an increasing number of entry fields 108 being displayed on the query field 106, a minimal amount of GUI 104 real-estate will be taken in order to display the entry fields 108.

Examples of the present disclosure can include functionality for adding and/or removing entry fields 108 from the query field 106. In an example, the functionality can include an expansion icon 114-4 and/or a contraction icon 114-1, 114-2, 114-3. For instance, a user can select the expansion icon 114-4 to add an additional entry field 108. Alternatively, a user can select one of the contraction icons 114-1, 114-2, 114-3 to remove an entry field 108. For instance, a user can select the contraction icon 114-1 to remove the first entry field 108-1 and the associated Criterion 1.

In an example, selection of the expansion icon 114-4 can result in display of an additional operator field 112 and an additional entry field 108. The additional operator field 112 and the additional entry field 108 can be displayed below the entry field 108-N in a manner similar to how operator field 112-1 and entry field 108-2 are displayed below entry field 108-1. The additional operator field 112 can indicate a relationship between the Criterion N in entry field 108-N and the additional entry field 108. Alternatively, selection of the contraction icon 114-1 can result in removal of the entry field 108-1 and Criterion 1, for example. In addition, selection of the contraction icon 114-1 can result in removal of the operator field 112-1 and any associated operator (e.g., Boolean operator 110). Upon selection of the expansion icon 114-4 and/or one of the contraction icons 114-1, 114-2, 114-3, a dimension of the query field 106 can be adjusted. For example, upon selection of the expansion icon 114-4, a vertical dimension of the query field 106 can be increased.

In an example, the expansion icons 114-4 and/or contraction icons 114-1, 114-2, 114-3 can reduce a difficulty associated with a user attempting to edit a particular criterion. For instance, in contrast to a single entry field that stretches horizontally across a GUI and displays only a portion of criteria that have been entered into the field, examples of the present disclosure can display all of the criteria that are being used. Additionally, examples of the present disclosure allow for subtraction or addition of criteria through selection of an expansion icon 114-4 or subtraction icon 114-1, 114-2, 114-3, rather than requiring a user to scroll through an entry field until finding a particular criterion and then issuing a command to delete the particular criterion.

In an example, the query field 106 can be displayed while maintaining the context of the data field 102. For instance, displaying the query field 106 does not change the formatting of the data and/or the formatting of the space that the data is presented on. As such, formatting such as line spacing between data, character spacing between data characters, data character size, data font, and/or data color can remain unchanged when displaying the query field 106. In addition, the formatting of the space, such as dimensions of the data field 102, margins associated with the data field 102, the number of pages required to display the data field 102 and/or query field 106 can remain unchanged when displaying the query field 106.

The query field 106 can be displayed as a tooltip on the GUI 104, in an example. For instance, the query field 106 can be displayed as a user selects the display icon 116 via the GUI 104. As such, the query field 106 can be hidden by default, thus preserving GUI 104 real-estate. The display icon 116 and/or other features present on the query field 106 can be selected via a mouse pointer, an eye tracker, touch screen, eye tracking hardware and/or software, and/or a keyboard. In an example, the display icon 116 can be selected to display the query field 106 when a mouse pointer is placed over the display icon 116. In an example, the query field 106 can be displayed when the display icon 116 is selected via the mouse pointer and/or a touch screen. In an example, the query field 106 can be displayed when the display icon 116 is selected through movement of the user's eye. For instance, devices such as augmented reality glasses and/or a display utilizing eye-tracking hardware and/or software can track movement of the user's eye and select the display icon 116 based on eye movement. In an example, the query field 106 can be displayed when the display icon 116 is selected via a keyboard.

In an example, the query field 106 can be displayed such that it covers a portion of the data field 102. For instance, the query field 106 can cover a fraction of the data field 102 to preserve GUI 104 real-estate.

Examples of the present disclosure can perform a data search based on a number of entries in the number of entry fields 108. For example, a database can be searched for data that includes Criterion 1 in the first entry field 108-1, Criterion 2 in the second entry field 108-2, and/or Criterion N in the N entry field 108-N. In an example, the data search can be based on the number of entries in the number of entry fields 108 and/or the number of operators in the operator fields 112-1, 112-2.

Examples of the present disclosure can display a result from the data search in the data field 102. In an example, results from a search returning data . that includes Criterion 1 in the first entry field 108-1, Criterion 2 in the second entry field 108-2, and/or Criterion N in the N entry field 108-N can be displayed in the data field 102. For instance, the results can be displayed in a list format in order of relevance associated with keywords in each result.

In an example, the query field 106 can be displayed concurrently with the results displayed in the data field 102. As such, the results displayed in the data field 102 can be viewed at the same time as criteria that have been entered into entry fields 108. For example, a user can view the criteria that have been entered into entry fields 108 without having to switch between different pages (e.g., one page containing the query field 106 and one page containing the data field 102).

In an example, the query field 106 can be displayed over the data field 102. For instance, the query field 106 can be displayed in the foreground and the data field 102 can be displayed in the background on the GUI 104. As such, a portion of the data field 102 may be covered by the query field 106. The query field 106 can be displayed over a portion of the data field 102 such that the query field 106 does not cover any logos, advertising, functionality, and/or data displayed on the data field 102.

In an example, a portion of the query field 106 can be translucent and/or transparent. As a result of a portion of the query field 106 being translucent and/or transparent, a user can see what is behind the query field 106. For example, a background of the query field 106 can be translucent and/or transparent so a user can see any logos, advertising, functionality and/or data that is displayed on the data field 102, behind the query field 106. GUI 104 real-estate can therefore be preserved even though a portion of the data field 102 is covered by the query field 106.

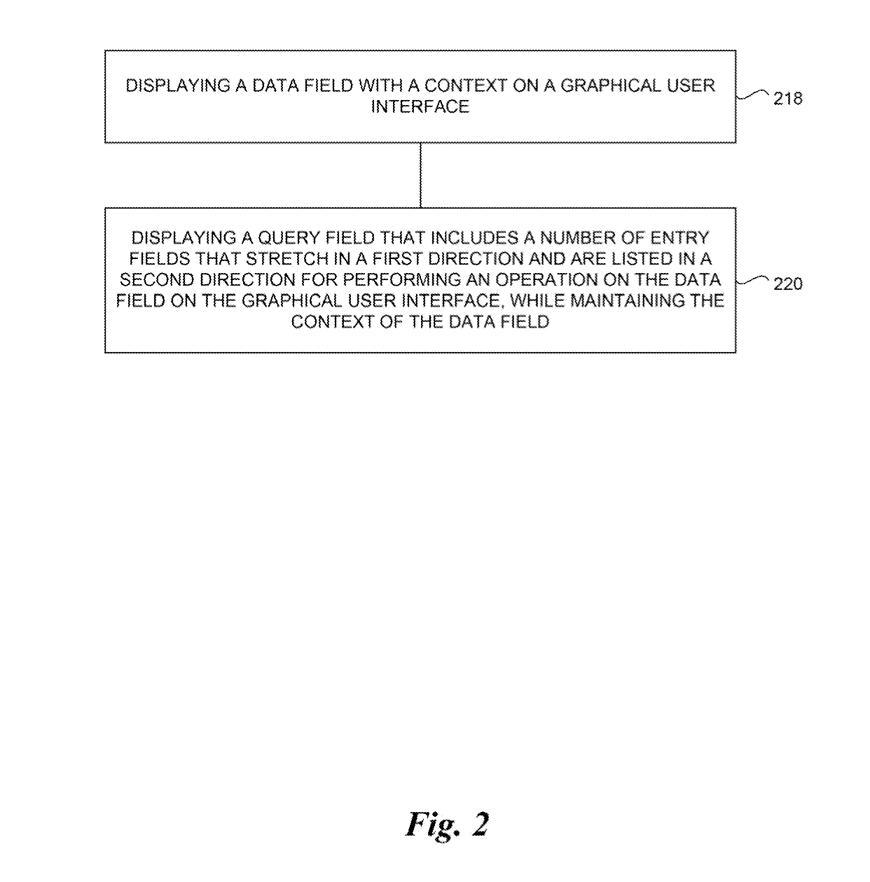

FIG. 2 is a flow chart illustrating an example of a method for performing data operations while preserving GUI real-estate according to the present disclosure. The method can include displaying 218 a data field with a context on the GUI. The context of the data can include characteristics associated with a visual presentation of the data on the GUI. As discussed herein, the context can include formatting of the data and/or formatting of the space that the data is presented on.

The method can include displaying 220 a query field that includes a number of entry fields that stretch in a first direction and are listed in a second direction for performing an operation on the data field on the GUI, while maintaining the context of the data field. In an example, the first direction can be horizontal in the graphical user interface and the second direction can be vertical in the graphical user interface. As such, the number of entry fields can be in a vertical list, allowing for each criterion entered into each entry field to be viewed by a user without having to scroll through a single entry field that lists multiple criteria.

As discussed herein, the query field can be displayed in a way that does not change the context of the data field. For example, displaying the query field 106 does not change the formatting of the data and/or the formatting of the space that the data is presented on.

In an example, the query field can be displayed as a tooltip on the GUI. For instance, the query field can be hidden by default until a user selects a display icon via the GUI, which can display the query field. By not displaying the query field when not in use, GUI real-estate can be preserved.

In an example, criteria can be entered into each of the number of entry fields included in the query field. The criteria can consist of, for example, a combination of letters, symbols, and/or numbers. In contrast to a single entry field that stretches horizontally across the GUI, which includes multiple criteria, upon entry of a criterion into each of the number of entry fields, each criterion can be viewed by a user of the GUI. For example, a user may have to scroll through a single entry field that stretches horizontally across the GUI to view each of the criteria. Additionally, only a portion of the multiple criteria can be seen at once in the single entry field due to the limited length of the single entry field.

In an example, performing the operation on the data field can include filtering the data field and/or performing a data search. Filtering the data field can include filtering a list of data, for example, that is displayed in the data field according to a criteria received for each of the number of entry fields. In an example, an unfiltered list of data can include 500 items and can be displayed in the data field. The unfiltered list can be filtered according to one or more criteria received for at least some of the number of entry fields. For instance, the list of 500 items can be reduced to 50 items upon filtering items out of the list that do not include the criterion received for each of the number of entry fields.

Performing a data search can include, in an example, performing a search of a database according to one or more criteria received for each of the number of entry fields. In an example, a list of data from a database that includes criteria received for at least some of the number of entry fields can be populated and displayed in the data field.

Examples of the present disclosure can perform a data search based on a number of entries in the number of entry fields. For example, a database can be searched for data that includes Criterion 1 in the first entry field, Criterion 2 in the second entry field, and/or Criterion N in the N entry field. In an example, the data search can be based on the number of entries in the number of entry fields and/or the number of operators in the operator fields.

In an example, the method can include creating a relationship between a first criterion entered into a first entry field and a second criterion entered into a second entry field via an operator that is displayed on the query field. As discussed herein, the operator can be a Boolean operator and/or a mathematical operator.

In an example, the method can include displaying the second entry field in response to the first criterion being entered into the first entry field. For instance, only the first entry field can be displayed by default upon display of the query field. Upon entry of the first criterion being entered into the first entry field, the second entry field can be displayed.

In an example, a dimension of the query field can increase upon display of the second entry field. For instance, a vertical length of the query field can increase, thus creating room for the second entry field to be displayed below the first entry field. By only displaying the first entry field upon display of the query field, the size of the query field can be kept smaller than if multiple entry fields are displayed upon display of the query field. As a result, GUI real-estate can be preserved.

The query field can be displayed as a tooltip on the GUI, in an example. For instance, the query field can be displayed as a user selects the display icon via the GUI. As such, the query field can be hidden by default, thus preserving GUI real-estate. In an example, the query field can be selected when a mouse pointer is placed over the icon. Alternatively, the query field can be selected when the display icon is selected via the mouse pointer and/or a touch screen. .

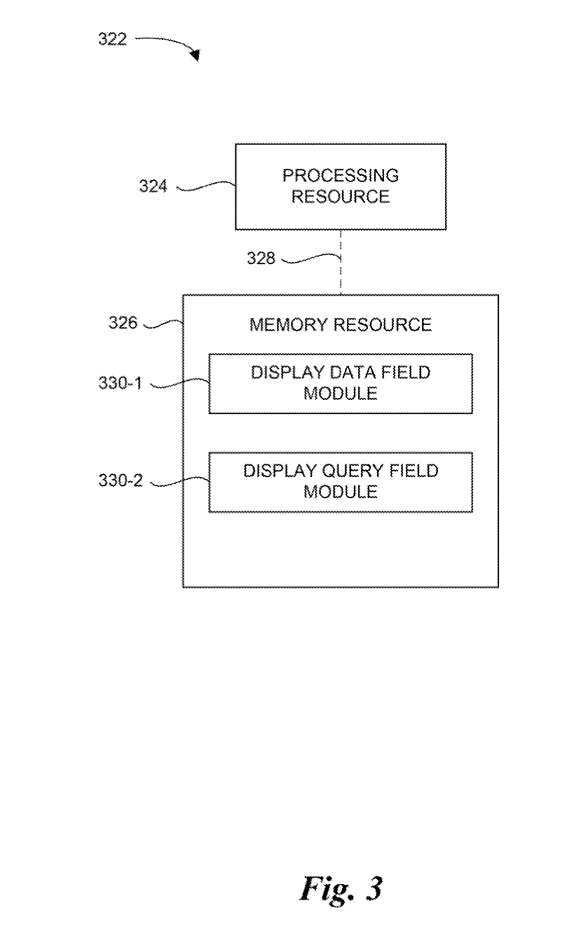

FIG. 3 illustrates a block diagram of an example of a computer-readable medium in communication with processing resources of a computing device according to the present disclosure. The computing device 322 can utilize software, hardware, firmware, and/or logic to perform a number of functions. The computing device 322 can be a combination of hardware and program instructions configured to perform a number of functions (e.g., actions). The hardware, for example, can include a number of processing resources 324 and a number of memory resources 326, such as a machine-readable medium (MRM) or other memory resources 326. The memory resources can be internal and/or external to the computing device 322 (e.g., the computing device 322 can include internal memory resources and have access to external memory resources). The program instructions (e.g., machine-readable instructions (MRI)) can include instructions stored on the MRM to implement a particular function (e.g., an action such as performing data operations while preserving graphical user interface real-estate). The set of MRI can be executable by one or more of the processing resources 324. The memory resources 326 can be coupled to the computing device 322 in a wired and/or wireless manner. For example, the memory resources 326 can be an internal memory, a portable memory, a portable disk, and/or a memory associated with another resource, e.g., enabling MRI to be transferred and/or executed across a network such as the Internet.

Memory resources 326 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory such as a hard disk, tape drives, floppy disk, and/or tape memory, optical discs, digital versatile discs (DVD), Blu-ray discs (BD), compact discs (CD), and/or a solid state drive (SSD), etc., as well as other types of machine-readable media.

The processing resources 324 can be coupled to the memory resources 326 via a communication path 328. The communication path 328 can be local or remote to the computing device 322. Examples of a local communication path 328 can include an electronic bus internal to a machine, where the memory resources 326 are in communication with the processing resources 324 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 328 can be such that the memory resources 326 are remote from the processing resources 324, such as in a network connection between the memory resources 326 and the processing resources 324. That is, the communication path 328 can be a network connection. Examples of such a network connection can include local area network (LAN), wide area network (WAN), personal area network (PAN), and the Internet, among others.

As shown in FIG. 3, the MRI stored in the memory resources 326 can be segmented into a number of modules 330-1, 330-2 that when executed by the processing resources 324 can perform a number of functions. As used herein, a module includes a set of instructions included to perform a particular task or action. The number of modules 330-1, 330-2 can be sub-modules of other modules. For example, the display query field module 330-2 can be a sub-module of the display data field module 330-1 and/or the display query field module 330-2 and display data field module 330-1 can be contained within a single module. Furthermore, the number of modules 330-1, 330-2 can comprise individual modules separate and distinct from one another. Examples are not limited to the specific modules 330-1, 330-2 illustrated in FIG. 3.

The display data field module 330-1 can comprise MRI that can be executed by the processing resources 324 to display a data field with a context on a graphical user interface. Various types of data can be displayed on the data field. For example, various types of data can include emails, wireless access points, user accounts, lists of results compiled from searches (e.g., internet searches), although examples are not so limited. As discussed herein, the context of the data field can include the formatting of the data and/or the formatting of the . space that the data is presented on.

The display query field module 330-2 can comprise MRI that can be executed by the processing resources 324 to display a query field that includes a number of entry fields that stretch in a first direction and are listed in a second direction for filtering the data field on the graphical user interface. As discussed herein, filtering the data field can include filtering a list of data, for example, that is displayed in the data field according to a criterion received for each of the number of entry fields.

In an example, the context of the data field can be maintained while displaying the query field. For instance, the formatting of the data and/or the formatting of the space that the data is presented on in the data field can remain unchanged upon display of the query field. In an example, the data field and the query field can be displayed concurrently. As such, the context of the data field existing before the query field is displayed can be the same context of the data field existing after the query field is displayed.

In an example, functionality for adding and removing entry fields from the query field can be displayed. In an example, the functionality can include expansion icons and/or contraction icons. For instance, a user can select the expansion icon to add an additional entry field. Alternatively, a user can select one of the contraction icons to remove one of the number of entry fields.

In an example, an updated filtered data field can be displayed upon entry of a criterion into the number of entry fields. For instance, the data field can be filtered based on the criterion entered into an entry field and the filtered data field can be displayed. As such, a data field that included several hundred entries can be reduced to several entries through filtering the data field based on the criterion entered into an entry field.

As used herein, “a” or “a number of” something can refer to one or more such things. For example, “a number of widgets” can refer to one or more widgets.

The above specification, examples and data provide a description of the method and applications, and use of the system and method of the present disclosure. Since many examples can be made without departing from the spirit and scope of the system and method of the present disclosure, this specification merely sets forth some of the many possible embodiment configurations and implementations.

What is claimed:

1. A method, comprising:
displaying a data field with a context on a graphical user interface; and
displaying a query field that includes a number of entry fields that stretch in a first direction and are listed in a second direction for performing an operation on the data field on the graphical user interface, while maintaining the context of the data field.

2. The method of claim 1, wherein the operation includes filtering the data field on the graphical user interface.

3. The method of claim 1, wherein the operation includes performing a data search.

4. The method of claim 1, wherein the method includes filtering the data field according to one or more criteria received for each of the number of entry fields.

5. The method of claim 1, wherein the method includes creating a relationship between a first criterion entered into a first entry field and a second criterion entered into a second entry field via an operator that is displayed on the query field.

6. The method of claim 5, wherein the operator is a Boolean operator.

7. The method of claim 5, wherein the operator is a mathematical operator.

8. The method of claim 1, wherein the method includes:
displaying the second entry field in response to the first criterion being entered into the first entry field; and
increasing a dimension of the query field to accommodate the second entry field.

9. The method of claim 1, wherein the first direction is horizontal in the graphical user interface and the second direction is vertical in the graphical user interface.

10. A non-transitory computer-readable medium storing a set of instructions executable by a processor to cause a computer to:
display a data field with a context on a graphical user interface;
display a query field that includes a number of entry fields that stretch in a first direction and are listed in a second direction for filtering the data field on the graphical user interface, while maintaining the context of the data field, wherein the data field and the query field are displayed concurrently.

11. The medium of claim 10, wherein the instructions executable by the processor include instructions to display functionality for adding and removing entry fields from the query field.

12. The medium of claim 10, comprising instructions executable by the processor to display an updated filtered data field upon entry of a criterion into the number of entry fields.

13. A system, the system comprising a processing resource in communication with a memory resource, wherein the memory resource includes a set of instructions and wherein the processing resource is designed to carry out the set of instructions to:
display a data field with a context on a graphical user interface;
display a query field that includes a number of entry fields that stretch in a direction horizontal to the graphical user interface and are listed in a direction vertical to the graphical user interface while maintaining the context of the data field;
perform a data search based on a number of entries in the number of entry fields;
display a result from the data search in the data field, wherein the data field and the query field are displayed concurrently.

14. The medium of claim 13, wherein the instructions executable by the processor include instructions to display the query field such that the query field covers a portion of the data field.

15. The system of claim 13, wherein the instructions executable by the processor include instructions to add an additional entry field upon selection of an expansion icon and remove one of the number of entry fields upon selection of a contraction icon.
